(19) United States
(12) Patent Application Publication
(10) Pub. No.: US 2013/0176174 A1
(43) Pub. Date: Jul. 11, 2013

(54) Method and System for Estimating Time of Arrival of Signals Using Maximum Eigenvalue Detection

(71) Applicants: Ramesh Annavajjala, Natick, MA (US); Philip Orlik, Cambridge, MA (US)

(72) Inventors: Ramesh Annavajjala, Natick, MA (US); Philip Orlik, Cambridge, MA (US)

(21) Appl. No.: 13/346,889

(22) Filed: Jan. 10, 2012

(51) Int. Cl. G01S 1/24

(52) U.S. Cl. 342/387

(57) ABSTRACT

A method estimates the time-of-arrival (ToA) of signals received via multipath channels. The received signal of a number of trials is first passed through a band-pass filter and then sampled. The presence of a channel tap within a time window is estimated by comparing a threshold to a largest eigenvalue of the covariance matrix of a time window. The signal samples are used to calculated a band region of a complete covariance matrix. After the band region has been updated for all signal samples, the covariance matrices for a moving window can be extracted from the band region. The ToA is estimated as the ending time of the leading window, which is the earliest window, such that the largest eigenvalue is larger than a given threshold.

### FIELD OF THE INVENTION

This invention relates to wireless radio-frequency (RF) localization, and more particularly to estimating the time-of-arrival (ToA) of ultra-wideband (UWB) signals (pulses) received via multipath channels.

### BACKGROUND OF THE INVENTION

A localization system needs to obtain range measurement from estimating the time-of-arrival (ToA) of a first path of a ranging signal. The ToA estimation for the first path is mainly affected by noise, and multipath components of wireless channels. In wireless channels characterized by dense multipath, the signal arriving via the first path is often not the strongest. When the signal is weak, accurate ToA becomes difficult. Conventional ToA estimation is generally accomplished by either an energy detection based estimator, or a correlation based estimator.

As shown in FIG. 1 for the energy detection based estimator, a received signal 101 is passed through a band-pass filter 102 to minimize out-of-band noise. The filtered signal 101′ is squared 103 and integrated 104 to collect energy during a symbol time. After low-rate sampling 105 at the symbol rate and analog to digital conversion (ADC), the first path is detected 107 by thresholding. The thresholding can detect a leading-edge to yield an estimate 108 of the ToA.

FIG. 2 shows the correlation based estimator. The received signal 201 is bandpass filtered 202, followed by sampling 203 at high rate, and then passed through a matched filter 204 (equivalently, correlated with the pulse shape itself). After the squaring 205, the first path is detected 206, from which the ToA can be estimated 207.

The energy detector has a relatively low-complexity because it uses analog square-law devices, operates on the symbol rate samples, and does not require the knowledge of the shape of the UWB pulse. Correlation-based estimator requires a high sampling rate, and more complex ADCs. The correlation-based estimator also requires the knowledge of the UWB pulse shape. Due to imperfection of the low-cost mobile UWB transmitters and distortion of the UWB signal during propagation, the perfect knowledge of the UWB pulse shape is generally unavailable.

ADC circuits sampling at a rate of 1 G (giga) samples-per-second, and higher, are available. However, perfect knowledge on the pulse shape is still an impractical assumption.

Therefore, it is desired to provide a method and system for non-coherent ToA estimation that is resilient to pulse shape distortion and also outperforms the energy detector given an availability of high-rate sampling.

### SUMMARY OF THE INVENTION

Embodiments of the invention provide a method for estimating the time-of-arrival (ToA) of ultra-wideband (UWB) received via multipath channels. The method outperforms the prior art energy detection based estimator, and does not require knowledge of the shape of the UWB pulses.

Specifically, a time-of-arrival (ToA) of a UWB signal received via multipath channels is estimated. A bandpass filter is applied to the received signal to minimize out-of-band noise, and a covariance matrix from samples of the bandpass filtered signal. The largest eigenvalues from the covariance matrix are thresholded to detect a first path and a leading edge of the received signal, from which the ToA is estimated.

### BRIEF DESCRIPTION OF THE DRAWINGS

FIG. 1 is a block diagram of conventional a method and system for estimating time-of-arrival (ToA) using energy detector;

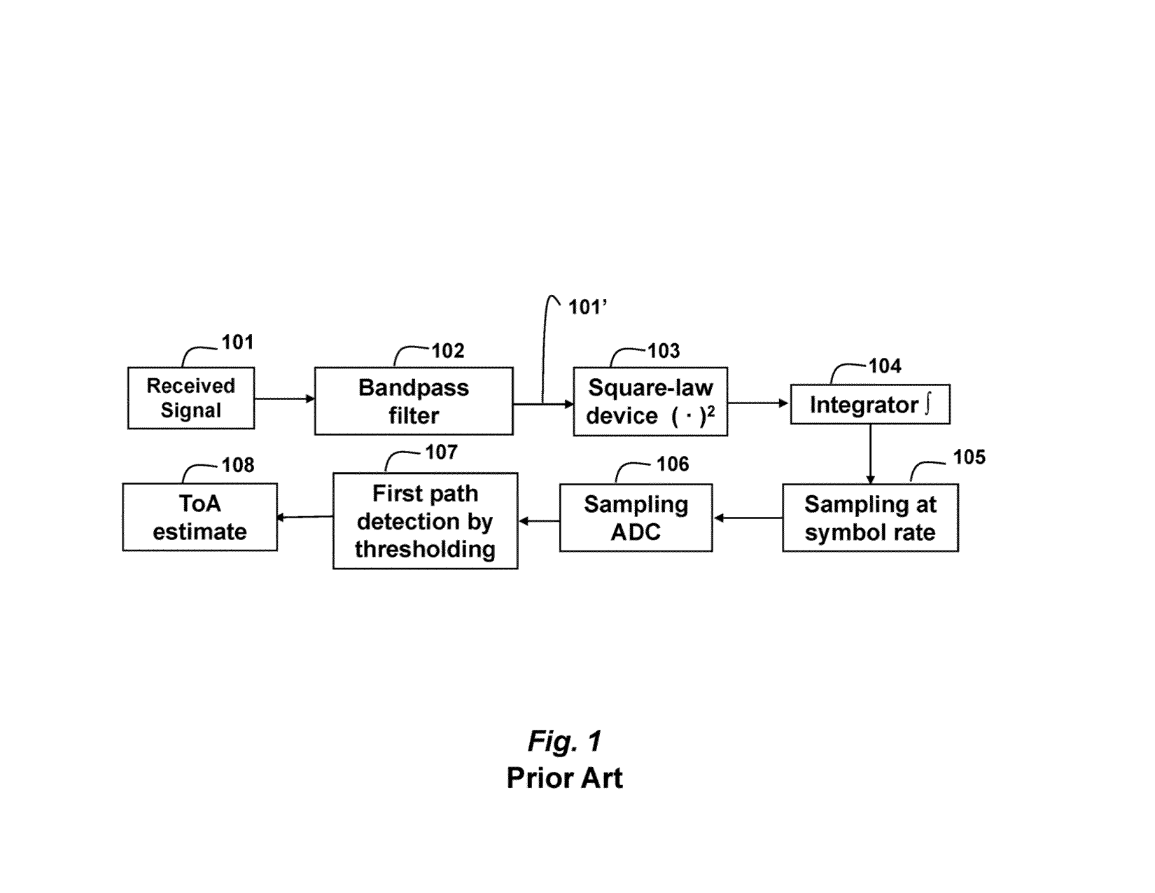

FIG. 2 is a block diagram of a conventional method and system for estimating time-of-arrival (ToA) using correlation-base estimator;

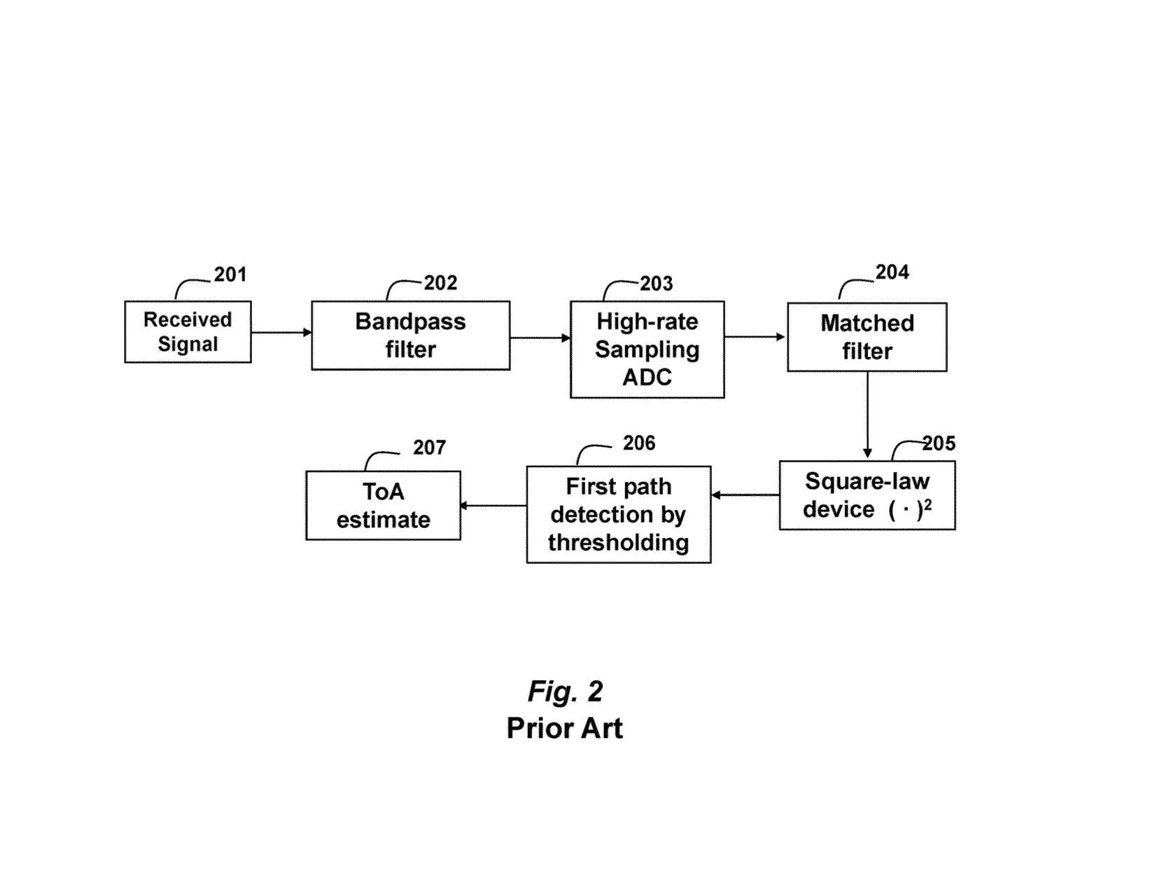

FIG. 3 is a block diagram of a method and system for estimating time-of arrival (ToA) using maximum eigenvalue detection according to embodiments of the invention;

FIG. 4 is a schematic of determining a covariance matrix of a time window according to embodiments of the invention; and

FIG. 5 is a schematic of band region of a complete covariance matrix for the purpose of reducing computational load according to embodiments of the invention.

### DETAILED DESCRIPTION OF THE PREFERRED EMBODIMENT

Embodiments of the invention provide a method for estimating the time-of-arrival (ToA) of ultra-wideband (UWB) signal (pulse) received via multipath channels.

We consider a multipath wireless channel H, so that the impulse response of the channel h over time t is

$$h ( t ) = {\sum }_{l = 1}^{L} {α}_{l} δ ( t - {τ}_{l} ) , \qquad ( 1 )$$

where t is time, α₁ is a complex value, L is a number of channel taps, δ is a Dirac delta function, and τ₁ is multipath delay associated with the l^{th} multipath.

Consider a transmitted pulse p(t). The received signal is then

$$r ( t ) = \text{?} {a}_{1} p ( t - \text{?} ) . \\ \text{?} \text{indicates text missing or illegible when filed}$$

If multiple consecutive pulses are transmitted within a short amount of time, then the channel remains relatively constant. Because a non-coherent receiver has no phase-locked loop to estimate a phase of a carrier frequency, the received baseband signal at different trials has independent phases.

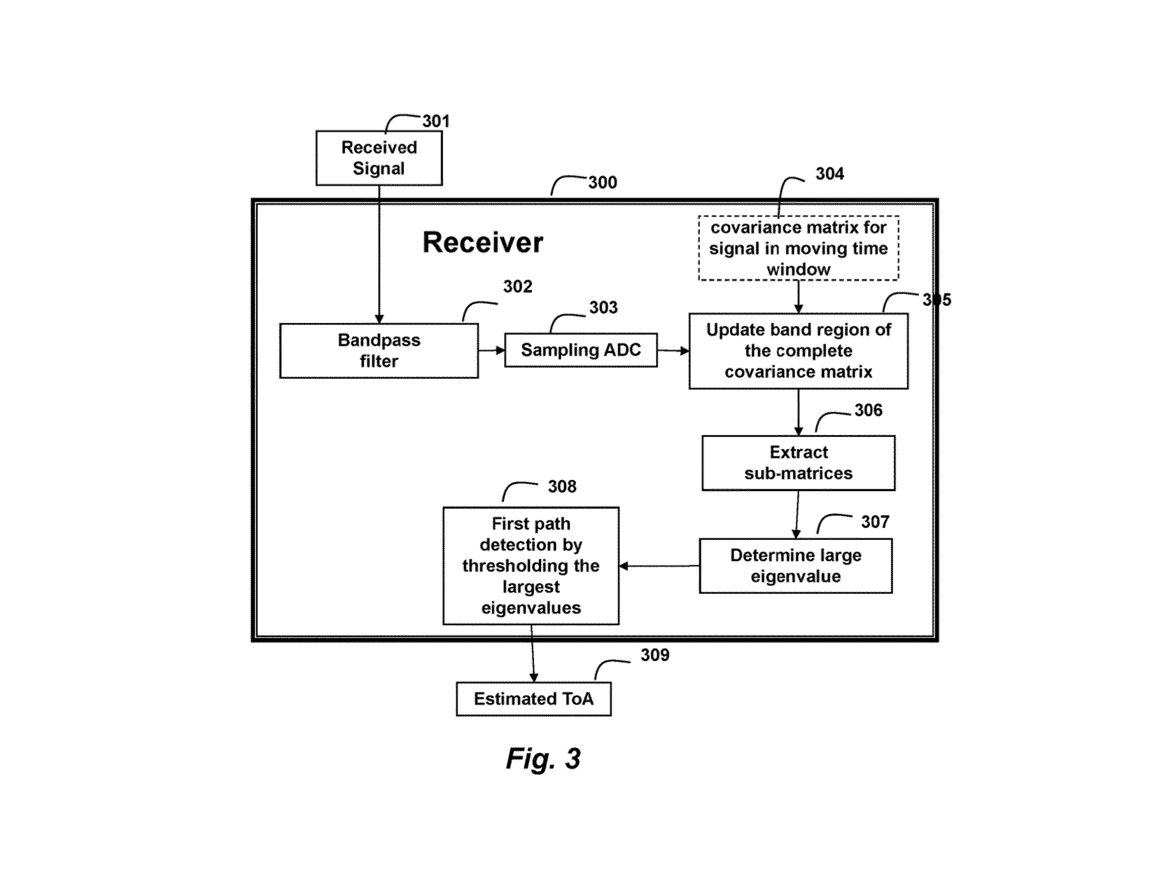

FIG. 3 shows the method and system to obtain TOA estimates according to embodiments of our invention. The steps of the method can be performed in a receiver 300.

When the receiver receives the ranging signal 301, the system bandpass filters 302 the signal to minimize out-of-band noise. The ADC 303 samples the filtered signal.

For a total of M trials, the signal samples are denoted as

$${r}_{1} {\text{?} [ {r}_{1} ( 0 ) \text{?} {r}_{1} ( 1 ) \text{?} … , {r}_{1} ( K ) ]}^{T} , \\ \text{?} {\text{?} [ \text{?} ( 0 ) \text{?} \text{?} ( 1 ) \text{?} … , \text{?} ( K ) ]}^{T} , \\ ⋮$$

$${r}_{M} {\text{?} [ {r}_{M} ( 0 ) \text{?} {r}_{M} ( 1 ) \text{?} … , {r}_{M} ( K ) ]}^{T} , \\ \text{?} \text{indicates text missing or illegible when filed}$$

In the above, 1, 2, . . . , M are trial indices, K is a total observation time index, and T is the vector transpose operator. The signal samples within a moving time window 304 are extracted to construct a covariance matrix.

Band regions in a complete covariance matrix are updated 305, and sub-matrices are extracted 306. The matrix is complete, when it is full, i.e., all entries exist.

Large eigenvalues are determined 307 for the sub-matrices. As known in the art, and defined herein, eigenvectors of a square matrix are non-zero vectors, which after being multiplied by the matrix, remain parallel to the original vector. For each eigenvector, the corresponding eigenvalue is the factor by which the eigenvector is scaled when multiplied by the matrix.

Thresholding on the large eigenvalues detects 308 a first path, from which the TOA can be estimated 309.

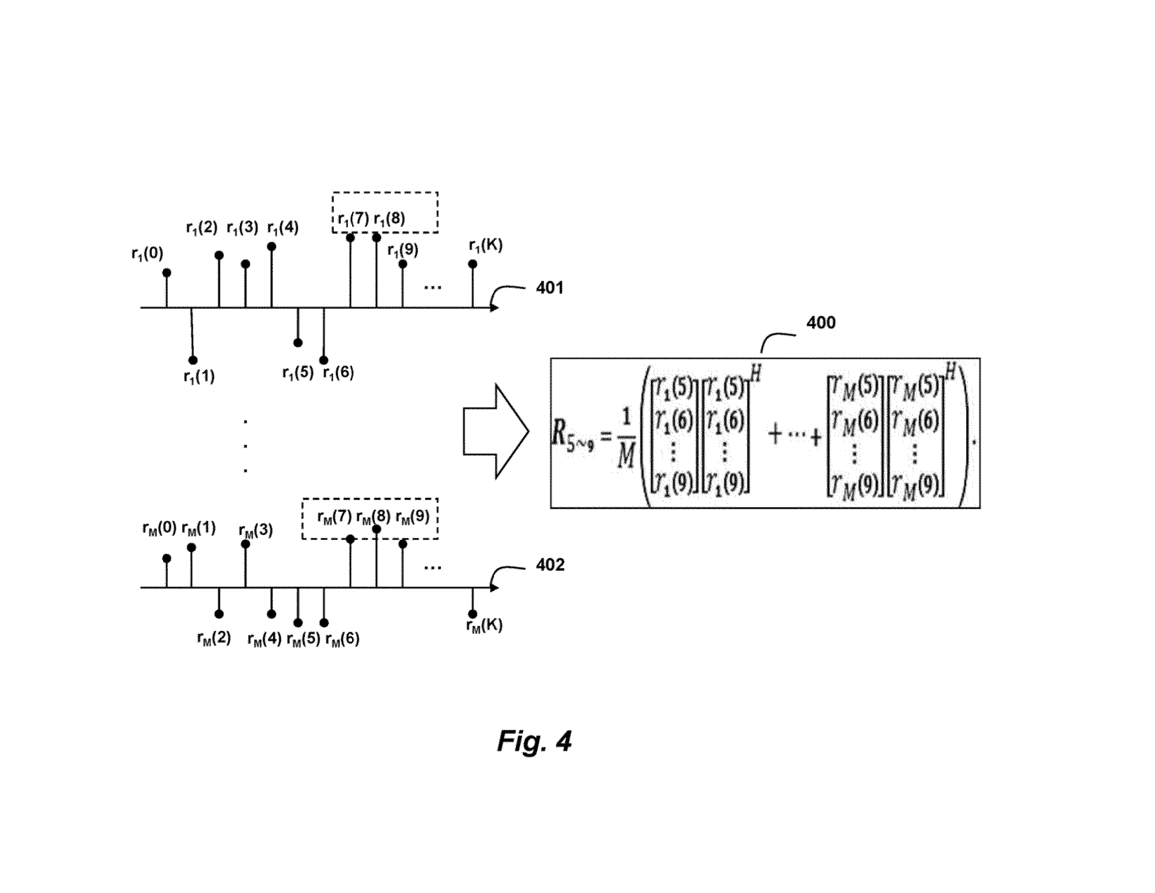

The schematic in FIG. 4 shows the determination for an example time window. The example is from time index 5 to time index 9 for samples r₁(0)-r₁(K) 401 through r_{M}(0)-r_{M}(K) 402. The covariance matrix 400 corresponding to the window from index 5 to time index 9, which is constructed according to

$$\text{?} = \frac{1}{M} ( {[ \begin{matrix}{r}_{1} ( \text{?} ) \\ {r}_{1} ( \text{?} ) \\ ⋮ \\ {r}_{1} ( \text{?} )\end{matrix} ] [ \begin{matrix}{r}_{1} ( \text{?} ) \\ {r}_{1} ( \text{?} ) \\ ⋮ \\ {r}_{1} ( \text{?} )\end{matrix} ]}^{H} + … + {[ \begin{matrix}{r}_{M} ( \text{?} ) \\ {r}_{M} ( \text{?} ) \\ ⋮ \\ {r}_{M} ( \text{?} )\end{matrix} ] [ \begin{matrix}{r}_{M} ( \text{?} ) \\ {r}_{M} ( \text{?} ) \\ ⋮ \\ {r}_{M} ( \text{?} )\end{matrix} ]}^{H} ) . \\ \text{?} \text{indicates text missing or illegible when filed}$$

The largest eigenvalue of this covariance matrix are used to determine whether there is a signal in this window.

To avoid duplicate calculations, and to save computational load, as shown in FIG. 3, the construction of the covariance matrix for a time window is alternatively done in two steps: construct a band region of the complete covariance matrix, and extraction of sub-matrices from the complete matrix.

The complete covariance matrix is

$$R = \frac{1}{M} ( r , {r}^{H} , + … + {r}_{M} {r}_{M}^{H} ) ,$$

where the (i,j)^{th} element of R is

$${R}_{i , j} = \frac{1}{M} ( {r}_{1} ( i ) {{r}_{1} ( j )}^{-} + … + {r}_{M} ( i ) {{r}_{M} ( j )}^{-} ) .$$

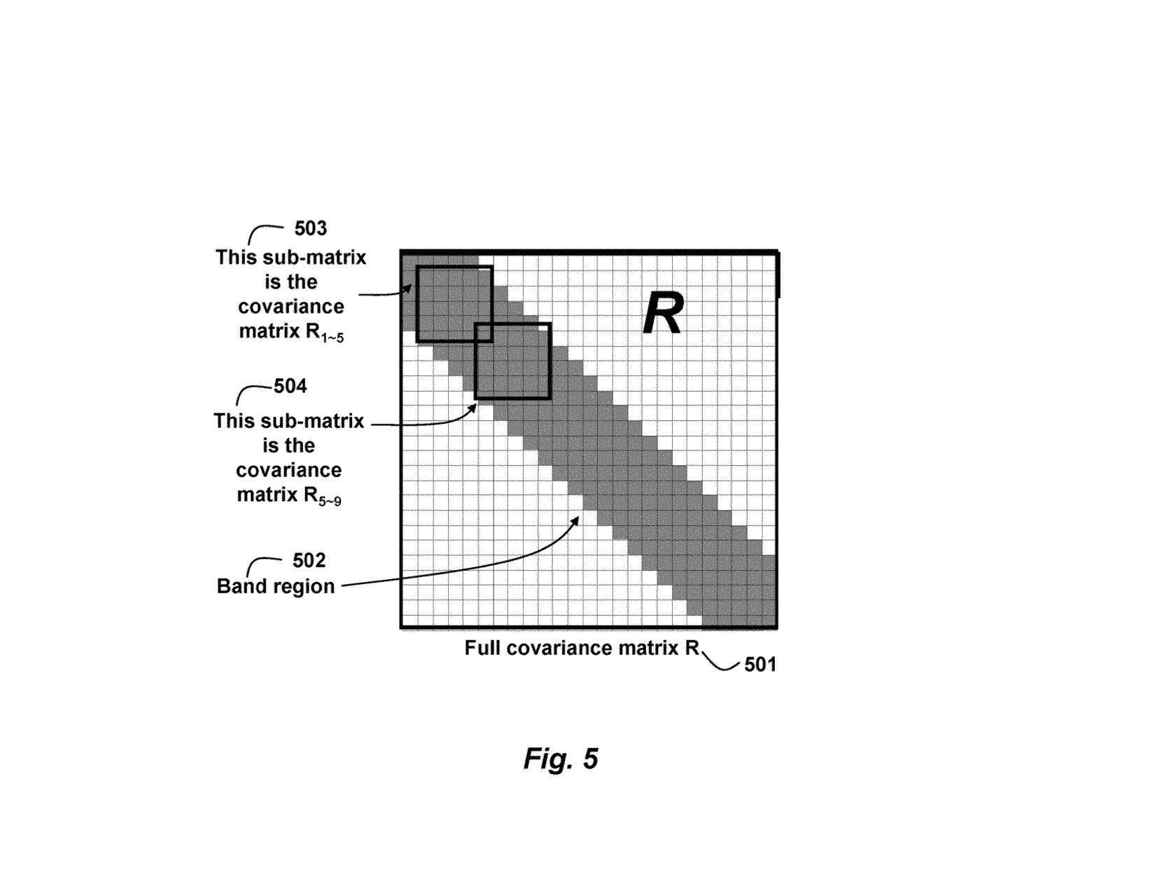

As seen in FIG. 5, the covariance matrices of a moving time window is in a band region of the complete covariance matrix R, e.g., R_{1˜5} for time window 1 to 5 and R_{5˜9} for time window 5 to 9. Therefore only the band region in FIG. 5 is useful and is determined accordingly. The width of the band region is equal to the length of the time window. After the completion of updating 305 the band region, the covariance matrix of the time window is extracted from the band region, as shown in FIG. 5.

The largest eigenvalue for the moving time window is tested for the existence of the signal. If the largest eigenvalue is larger than a threshold γσₙ², then the signal is in the window; otherwise, there is no signal exists in the window. In the threshold, σ² is the variance of the noise, and λ is a function of maximum eigenvalues of the covariance matrix.

The window with a leading edge is defined as the first window with a largest eigenvalue that is larger than the threshold γσₙ². Then, the ToA is estimated 309 to be the end time of the window with the leading edge.

Selecting the threshold is important for accurate ToA estimation. For different channel models and at different signal-to-noise ratio (SNR) values, an optimal threshold can be selected to minimize the average estimation error. The evaluation of the average error is can be done by numerical simulations or experiments.

Alternatively, the threshold is selected to achieve a predetermined false alarm rate for a noise-only time window. For a distribution of the largest eigenvalue of a real-valued noise-only, the Wishart matrix approaches the Tracy-Widom distribution of order 1 (TW1) as both the number of trials and dimension approaches infinity.

We denote the Wishart matrix A as A=XX^{H} where X=(X [symbol] )_{M} [symbol] has entries which are independent and identically distributed (i.i.d) X [symbol] [symbol] N(0,1). The distribution of

$$\frac{{λ}_{max} ( {A}_{1} ) - {μ}_{1}}{{υ}_{1}}$$

$$where$$

$${μ}_{1} = {( \sqrt{M - 1} + \sqrt{W} )}^{2}$$

$${υ}_{1} = ( \sqrt{M - 1} + \sqrt{W} ) {( \frac{1}{\sqrt{M - 1}} + \frac{1}{\sqrt{W}} )}^{1 / 3}$$

approaches to TW1.

The cumulative distribution function (CDF) of TW1 is

$${F}_{1} ( s ) = exp \{ - \frac{1}{2} {\int }_{S}^{∞} q ( x ) + ( x - s ) {q}^{2} ( s ) d x \} ,$$

where s is the value at which the CDF is to be evaluated, and q( ) solves a non-linear Painleve Il differential equation

q′(x)=xq(x)+2q³(x).

Given a false alarm rate P_{fa}, the threshold γσₙ² for the noise-only time window with window length L, the number of trials M, and noise variance σₙ², is the probability

P_{fa}=Pr{γ_{max(R}_{ₙₒᵢₛₑ}₎≧γσₙ²}

Then, the threshold is derived as

$$\text{?} - \frac{( \text{?} + {F}_{1}^{- 1} ( 1 - {P}_{fa} ) ) + \text{?}}{M} . \\ \text{?} \text{indicates text missing or illegible when filed}$$

It is generally difficult to evaluate F₁ or F⁻¹₁. The use of look-up table that is constructed off-line for a given storage constraint is convenient.

For a complex-valued noise-only Wishart matrix, the distribution of the largest eigenvalue approaches to Tracy-Widom distribution of order 2 (TW2). The distribution of

$$\frac{{λ}_{max ( A )} - \text{?}}{\text{?}}$$

$$\text{?} \text{indicates text missing or illegible when filed}$$

where
A=XX^{H} and X=(X [symbol] )_{M} [symbol] has entries which are i.i.d. X [symbol] [symbol] CN(0,1) and

$$\text{?} = ( \sqrt{M} + \sqrt{L} \text{?} \\ \text{?} ( \sqrt{M} + \sqrt{L} ) ( \frac{1}{\sqrt{M}} + \frac{1}{\sqrt{L}} \text{?} \\ \text{?} \text{indicates text missing or illegible when filed}$$

### has a CDF

F [symbol] (s)=exp{−∫ [symbol] ^{∞} [symbol] − [symbol] )q(s)dx}

where q is the non-linear Painleve H function. Similarly, given a P_{fa} for

Pr{λ_{max(R}_{ₙₒᵢₛₑ}₎≧γσₙ²},

the threshold is

$$\text{?} = \frac{( \text{?} + \text{?} ( 1 - {P}_{fa} ) ) + \text{?}}{M}$$

$$\text{?} \text{indicates text missing or illegible when filed}$$

### Effect of the Invention

Due to the fine delay resolution in ultra-wideband (UWB) wireless propagation channels, a large number of multipath components (MPC) can be resolved, and the first arriving MPC might not be the strongest one. This makes time-of-arrival (ToA) estimation, which essentially depends on determining the arrival time of the first MPC, highly challenging.

The invention considers non-coherent ToA estimation given a number of measurement trials, at moderate sampling rate and in the absence of knowledge of pulse shape.

The ToA estimation is based on detecting the presence of a signal in a moving time delay window, by using a largest eigenvalue of the sample covariance matrix of the signal in the window.

The energy detection can be viewed as a special case of the eigenvalue detection. Max-eigenvalue detection (MED) generally has superior performance, due to the following reasons:
i. MED collects less noise, namely only the noise contained in the signal space; and
ii. if multiple channel taps fall into the time window, the MED detector can collect energy at all taps.

The method operates at moderately high sampling rate, and does not need the knowledge of the pulse shape and imposes little computational complexity. The max-eigenvalue method only collects the noise energy distributed in the signal subspace, which is an advantage over the conventional energy-detection method.

The method avoids duplicate calculations for adjacent time window to reduce the computational load. The selection of the threshold is also discussed using random matrix theory. Simulation results in IEEE 802.15.3a and 802.15.4a channel models validate the higher accuracy of the max-eigenvalue method.

Thus, our thus represents an attractive alternative for low-complexity receivers in UWB ranging systems, which outperforms the energy detection in networks designed according to the IEEE 802.15.3a and 802.15.4a standards.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for estimating a time-of-arrival (ToA) of a signal, comprising:
receiving the signal via multipath channels, wherein the signal is an ultra-wideband (UWB) pulse;
applying a bandpass filter to the received signal to minimize out-of-band noise;
constructing a covariance matrix from samples of the bandpass filtered signal;
determining largest eigenvalues from the covariance matrix;
thresholding the largest eigenvalues to detect a first path and a leading edge of the received signal; and
estimating the ToA based on the leading edge.

2. The method of claim 1, wherein an impulse at time t of the multipath channel H is
$$h ( t ) = {\sum }_{l = 1}^{L} {α}_{i} δ ( t - {τ}_{l} ) , \qquad ( 1 )$$
where t is time, α=i is a complex value, L is a number of channel taps, δ is a Dirac delta function, and τ is multipath delay of the multipath channel, and the received signal, corresponding to a transmitted pulse p(t), is
$$r ( t ) = \text{?} \text{?} p ( t - \text{?} ) . \\ \text{?} \text{indicates text missing or illegible when filed}$$

3. The method of claim 1, wherein the received signal at different trials has independent phases.

4. The method of claim 1, wherein the samples are
$${r}_{1} = {[ {r}_{1} ( 0 ) \text{?} {r}_{1} ( 1 ) \text{?} … , {r}_{1} ( K ) ]}^{T} , \\ \text{?} = {[ \text{?} ( 0 ) \text{?} \text{?} ( 1 ) \text{?} … , \text{?} ( K ) ]}^{T} , \\ ⋮$$
$${r}_{M} = {[ {r}_{M} ( 0 ) \text{?} {r}_{M} ( 1 ) \text{?} … , {r}_{M} ( K ) ]}^{T} , \\ \text{?} \text{indicates text missing or illegible when filed}$$
where 1, 2, . . . , M are trial indices, K is a total observation time index, and T is a transpose operator.

5. The method of claim 1, wherein the covariance matrix is complete, and further comprising:
extracting sub-matrices from the complete covariance matrix, and the largest eigenvalues are determined from the sub-matrices.

6. The method of claim 1, wherein the samples use a moving time window over time steps.

7. The method of claim 1, wherein a threshold is γσₙ², where σ² is a variance of the out-of-band noise, and γ is a function of maximum eigenvalues of the covariance matrix.

8. The method of claim 7, wherein the ToA is estimated as last sample of the time window in which the largest eigenvalue exceeds the threshold.

9. A method for estimating a time-of-arrival (ToA) of a signal, comprising:
receiving the signal via multipath channels, wherein the signal is an ultra-wideband (UWB) pulse;
applying a moving time window to the signal over time steps;
taking, from the moving window at each time step, samples to construct a covariance submatrix;
determining a largest eigenvalue in each submatrix;
determining, time-wise, a first submatrix with the largest eigenvalue exceeding a threshold; and
setting the ToA to a last time instance in the moving window corresponding to the first submatrix.
